(19) United States
(12) Patent Application Publication
(10) Pub. No.: US 2004/0256296 A1
(43) Pub. Date: Dec. 23, 2004

(54) Method for debarking in a drum, and separation of bark from a log flow

(76) Inventor: Antti Tohkala, Pori (FI)

Correspondence Address: BURNS DOANE SWECKER & MATHIS L L P, POST OFFICE BOX 1404, ALEXANDRIA, VA, 22313-1404, US

(21) Appl. No.: 10/484,523

(22) PCT Filed: Jun. 11, 2003
(86) PCT No.: PCT/FI03/00463

(30) Foreign Application Priority Data
Jun. 12, 2002 (FI) 20021134

(51) Int. Cl. B07B 1/18; B07C 5/14

(52) U.S. Cl. 209/284; 209/517

(57) ABSTRACT

The invention relates to a continuously operating drum debarking method for processing logs. The logs to be de-barked into a debarking drum (4′) having no bark discharge openings in the shell. The logs together with the bark loosened therefrom are discharged to a downstream bark separating system. Therein, the logs are subjected mutual movements resulting in the removal of bark from about the logs. The thus separated bark pieces are further discharged onto a conveyor system located under the separating equipment.

The present invention relates to a debarking drum and a debarking process and a method for separating loose bark from a mixed flow of wood and bark.

Prior to chipping and subsequent defibering processes in pulp and paper industry, wood must be debarked. Depending on the type and quality of cellulose or paper being manufactured, bark must be removed from logs almost completely. Conventionally, debarking is carried out in a purpose-designed debarking drum, wherein logs are debarked in a crosswise flailing or parallel tumbling process. The debarking drums are equipped along their shell with bark discharge openings via which a major portion of bark pieces loosened from logs are removed from the wood flow. In certain wood species used as raw material, such a birch, for instance, the bark is very tightly adhering and, resultingly, the bark separates at a late stage of debarking thus not having enough time to become entirely discharged via the bark openings. A great number of tropical wood species such as green logs of Acacia wood and certain Eucalyptus wood species are especially problematic in drum debarking inasmuch as the long stripes of tough bark characteristic of these species tend to separate preferentially as large pieces that are difficult to discharge via the bark openings, but instead are carried along with the wood flow onto the chipper feed conveyor. Hence, the chipper feed conveyor line situated downstream of the debarking drum is generally equipped with a roller track whereon the remaining loose bark pieces are intended to be separated from the wood flow.

In a crosswise flailing debarking process, the drum length is typically 20 to 35 m with a diameter of 4.5 to 5.5 m. In the parallel tumbling debarking process, the drum length is even longer, however, generally having the drum diameter made smaller. Bark pieces exiting via the bark discharge openings through the drum shell fall by gravity along slanted bark collecting walls situated below the drum onto a bark discharge conveyor that takes the bark to further processing. The bark discharge conveyor must be made at least as long at the debarking drum. To avoid dust problems, the drum must be enclosed in a dust hood. Sealing such dust hoods against the drum increases the erection costs of the debarking line. Leaks occur frequently in the bark collecting walls, and debris accumulates on the floor of the debarking line building. Substantial steel constructions are needed for enclosing large drums and bark collecting walls.

The bark discharge openings disposed along the drum shell are typically 40 to 60 mm wide and 300 to 600 mm long. When slender logs stick in the drum openings, they break thus releasing sticks and causing loss of wood material. The trend to use ever thinner logs as cellulosic fiber raw material results in continually increasing wood losses.

Furthermore, the drum construction is weakened by the bark discharge openings. Attempts have been made to compensate for this problem by way of increasing the drum shell thickness. The disposition of the bark discharge openings also curtail the location of support members thus in turn increasing the cost of the drum construction. Collection of bark from under the drum is generally carried out by means of a bark discharge conveyor that conventionally is a belt conveyor. Due to the narrow width of the belt conveyor, slightly slanted bark collecting walls must be adapted under the drum for directing the bark onto the belt conveyor. The inclination angle of the bark collecting walls in regard to the vertical plane may not be larger than 30°. If the inclination from the vertical is made larger, the bark pieces do not slide down sufficiently freely, whereby bark starts to form agglomerates. Due to the bark collecting walls and the bark discharge conveyor, the drum must be located relatively high from the floor level. Such an elevated drum requires a massive foundation and plural stairways to the elevated service catwalks.

Having the drum at an elevated level also necessitates a longer drum feed conveyor inasmuch as the upward slope of the feed conveyor is restricted to a small angle. By being the largest and, generally, the uppermost piece of equipment in the debarking section, the elevation level of the drum's highest point determines the height of the debarking line building. Among other investment factors, the height of the debarking line building has a direct effect on the plant construction costs.

Inasmuch as the prior-art goal has been to perform bark discharge via the discharge openings through the drum shell, the log discharge end of the drum has been equipped with different kinds of gate means intended to retain the bark pieces in the drum. Typically, an adjustable gate at the drum inlet has partially served this task. Such a gate, however, causes log damage and increased loss of wood material.

The method according to the invention disposes with the need for placing a long bark discharge conveyor and slanted bark collecting walls under the drum, as well as a dust hood over the drum. Also the problems associated with the bark discharge openings are eliminated. The method is characterized in performing debarking in a drum having a solid shell, whereby removal of all loose bark pieces from the log flow is carried out not earlier than on the roller track situated downstream of the debarking drum.

In the following, the invention and its characteristic features are elucidated by making reference to appended drawings, in which

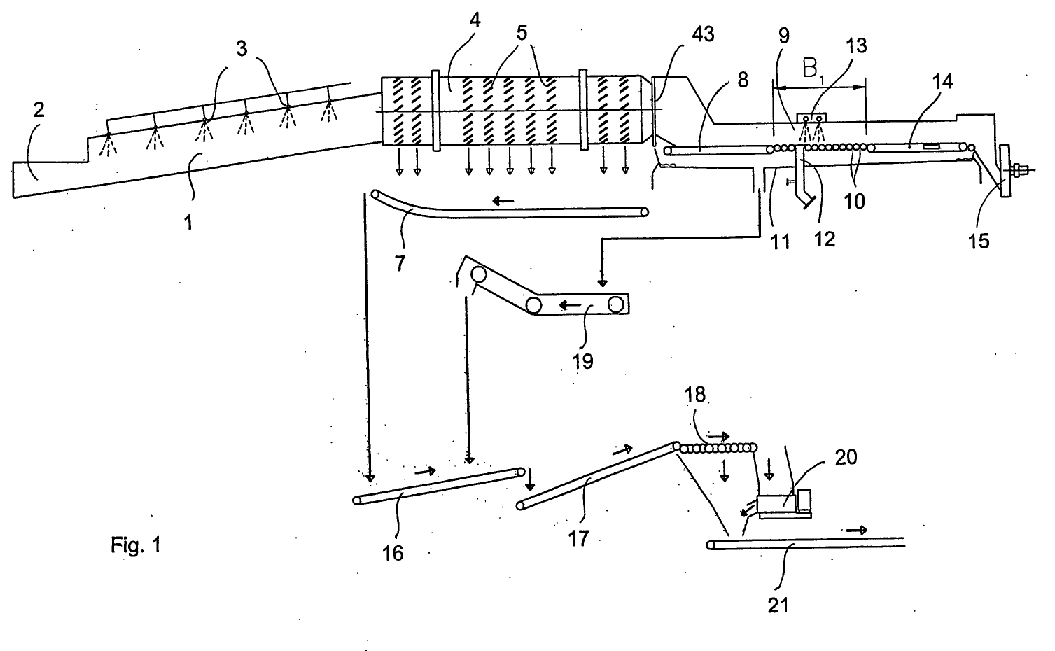

FIG. 1 shows a schematic diagram of a conventional debarking process operating under conditions wherein logs are stored frozen for a time during a year;

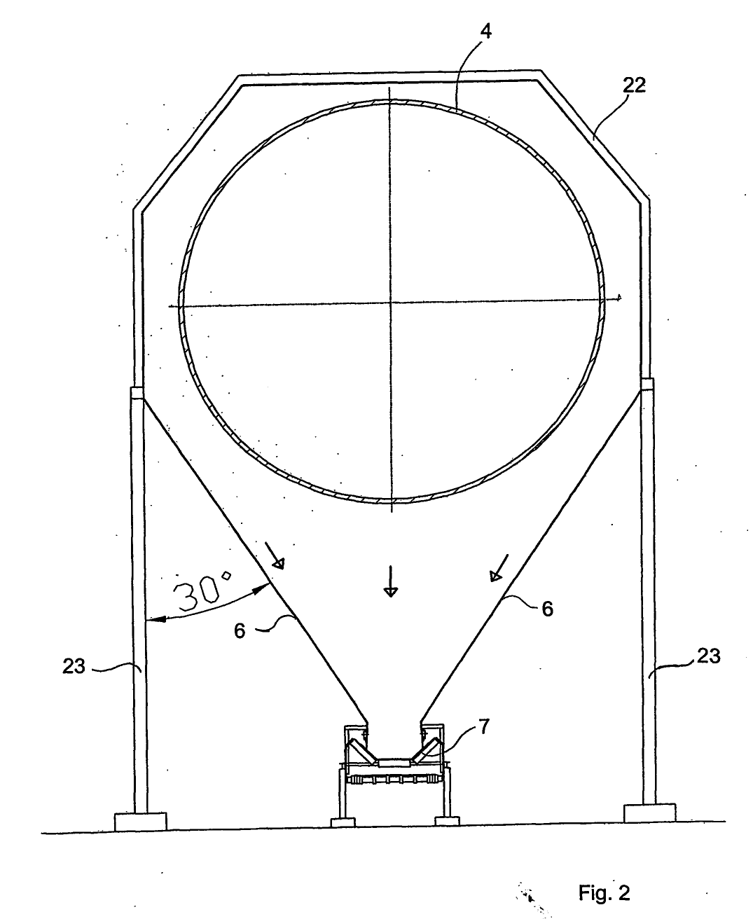

FIG. 2 shows a cross-sectional view of an enclosed debarking drum;

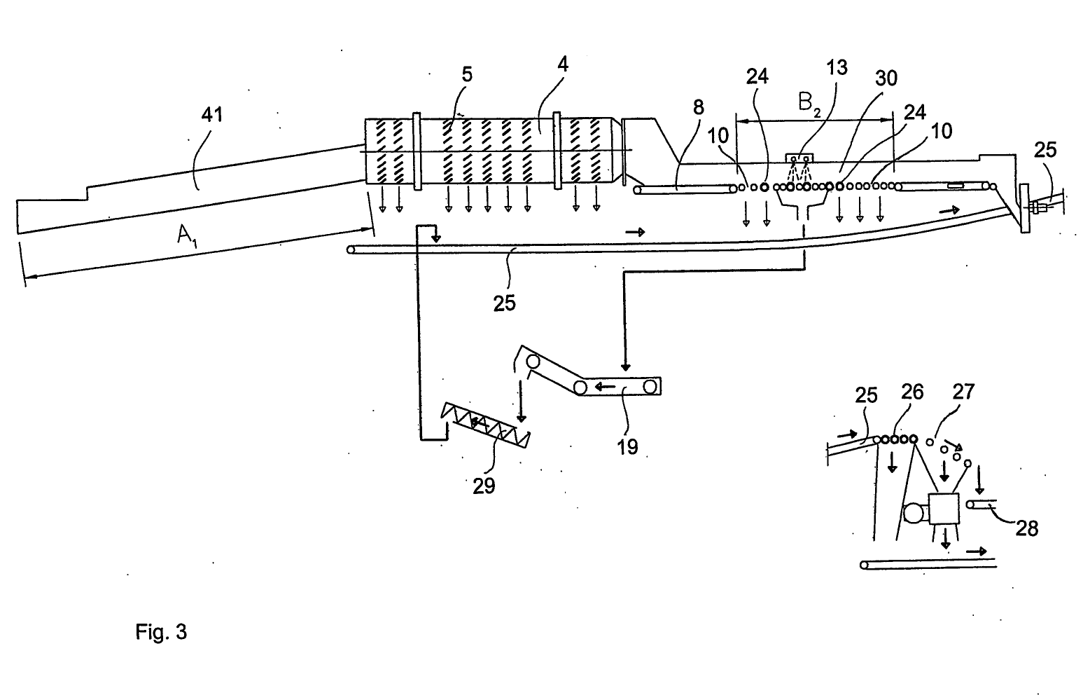

FIG. 3 shows a schematic diagram of a conventional debarking process operating under conditions not hampered by freezing;

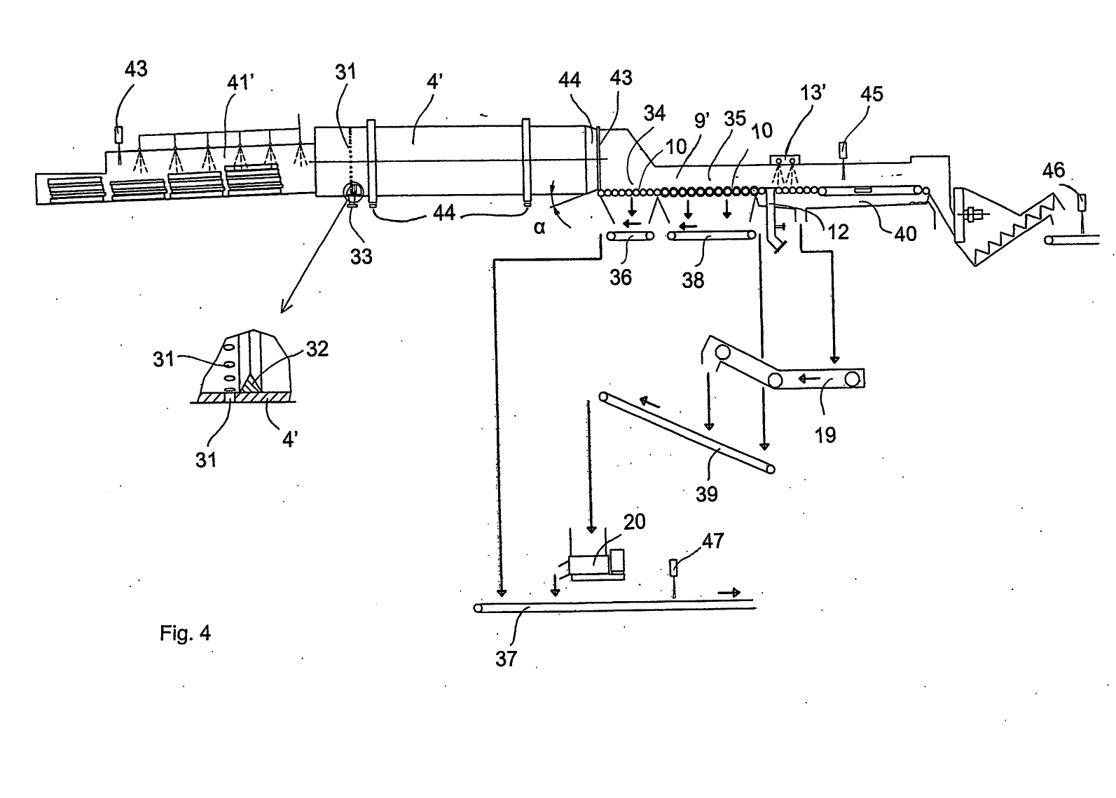

FIG. 4 shows a schematic diagram of a debarking process line according to the invention operating under conditions wherein logs are stored frozen for a time during a year;

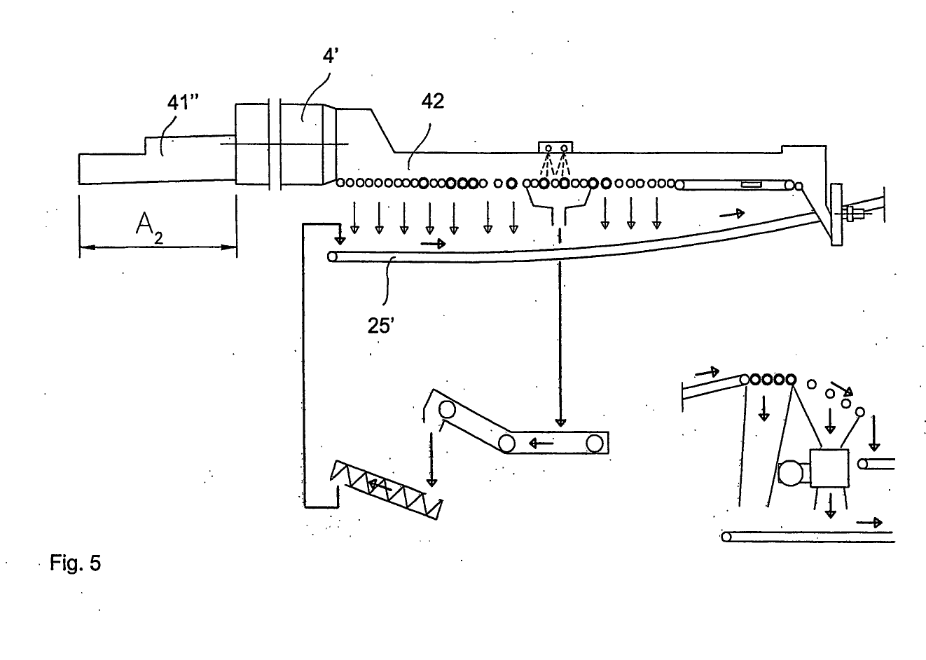

FIG. 5 shows a schematic diagram of a debarking process line according to the invention operating under conditions not hampered by freezing; and

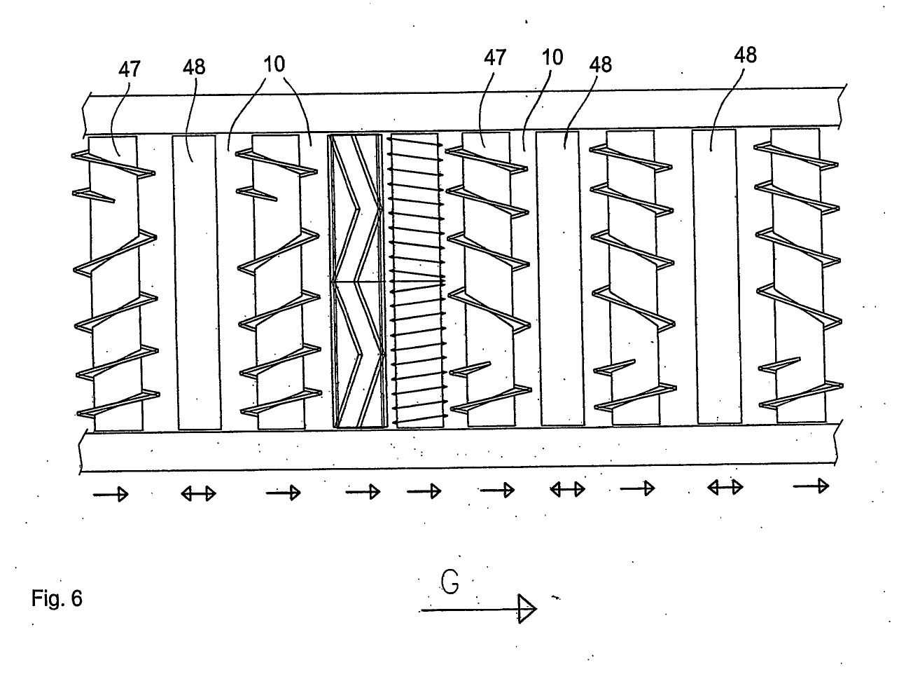

FIG. 6 shows a roller track used in the method according to the invention.

Referring to FIG. 1, therein is shown a conventional debarking process typically employed in the Nordic countries, for instance. Logs to be debarked are loaded onto the receiving end 2 of a debarking drum feed conveyor 1. During the wintertime, the logs are thawed with warm water ejected from water spray nozzles 3 adapted above the feed conveyor. Conveyor 1 feeds logs at a constant rate into the debarking drum 4. Generally, feed conveyor 1 is made upward ramped due to the elevated position of drum 4. The drum slanted in the downstream direction of logs is driven at a relatively slow speed. The rotary motion of the drum subjects the logs, which are in random position in the drum 4, to a flailing and rubbing action against each other thus causing the loosening of bark from the outer surface of the logs. Coniferous round-wood loses in the drum a major portion of its bark that falls by gravity through the bark discharge openings 5 in the drum shell onto slanted bark collecting walls 6 located under the drum and further onto a bark discharge conveyor 7 (FIG. 2).

The logs are discharged from the drum via a gate 43 onto a drum discharge conveyor 8. Next downstream of the conveyor is adapted a roller track 9 with a length denoted in the diagram as B₁ wherein the remaining bark pieces are separated from the wood flow. The loose pieces of bark fall by gravity via interroll gaps 10 into a water trough 11. The roller track 9 also includes a rock trap 12 and a log washer 13 preceding the chipper. Downstream of the roller track is located a feed conveyor 14 that transfers the logs to a chipper 15. The water trough 11 is extended to reach under each one of the conveyors 8, 9 and 14 inasmuch as a certain amount of bark and wood pieces will inevitably fall off from the conveyors and their gaps. The bark discharge conveyor 7 placed below the drum transfers bark pieces typically via two subsequent conveyors 16 and 17 onto a rotary disc screen 18. Bark and wood pieces landing in the water trough 11 travel along with the water flow onto a sieve bottom drainer 19. Scrapers move solid particles across the drainer sieve plates, whereby water is drained by gravity into a circulating water sump tank (not shown in diagrams). From drainer 19 the bark pieces are passed onto the same conveyor 16 that initially receives bark from under the debarking drum. The disc screen 18 separates smaller pieces of wood and bark apart from larger ones. While the smaller pieces can directly fall onto a conveyor 21, the larger pieces are first passed for comminution on a bark shredder 20, wherefrom the pieces are discharged further onto the conveyor 21.

In FIG. 2 is shown a cross-sectional view of the debarking drum 4 with its bark collecting walls 6. At the bark discharge openings, the drum 4 is provided with a sealed enclosure 22. The diagram also shows the support structures 23 of the enclosure elements.

In FIG. 3 is shown a typical debarking process for Acacia or Eucalyptus wood species. As no thawing equipment is required, the length A₁ of the drum feed conveyor 41 is dictated by the elevation level of the drum inlet. The length B₂ of the bark screening roller track 30 is made greater than dimension B₁ in FIG. 1. The roller track must be made long, because only 20 to 30% of bark is discharged through the bark discharge openings in the drum shell. The roller track is implemented using, e.g., helical flight rolls 24 that inflict a strongly shaking force on the flow of wood and bark pieces. The interroll gaps 10 are also made larger. Due to the more effective bark screening, also larger pieces of wood may escape along with the discharged bark. A bark discharge conveyor 25 located below the drum also passes under the chipper feed line, whereby it transfers bark and wood pieces to a roller screen 26 that separates smaller pieces apart from larger ones in the same fashion as disc screen 18 shown in FIG. 1. Next downstream of the roller screen 26 is located a wood recovery roller screen 27 serving to pass larger pieces of wood retained in the process with the help of a conveyor 28 and a separate chipper.

As the roller track 30 of the chipper feed line also includes a log washer 13, the process additionally needs a sieve drainer 19 and, for instance, a screw conveyor 29 serving to move the bark pieces collected from the sieve drainer to a bark conveyor 25.

In conventional debarking lines adapted for Acacia and Eucalyptus wood species, notwithstanding a generous overdimensioning of the debarking drum, as much as up to 80% of the bark removed in the drum from the logs can travel along with the debarked logs onto the downstream roller track, instead of becoming discharged from the drum via the bark discharge openings in the drum shell. Resultingly, it has been necessary to optimize the roller tracks downstream of the drum for maximum efficiency of bark removal. However, herein arises a new problem from the higher loss of wood along with the bark flow. The loss increase is due to the excessively long retention of logs in the drum, which causes log damage, and larger gaps in the bark separating roller track. Hence, it has been necessary to develop equipment 27 such as shown in FIG. 3 for recovery of short logs from the bark flow.

In FIG. 4 is shown a debarking process according to the invention. Lacking actual bark discharge openings, herein the debarking drum 4′ has an almost solid shell. At the inlet end of the drum, however, the shell may be provided with holes 31 smaller than normal bark discharge openings in order to separate sand and smaller rocks from the wood and bark flow. In order to augment the separation of sand, annularly along the interior perimeter of drum 4′, just next downstream of the sand discharge holes 31, is placed a shallow stop ring 32 that prevents sand separated from the logs from proceeding further in the drum 4′. The particulate matter passing through the sand discharge holes can be collected with the help of, e.g., a conveyor 33 adapted to operate at right angles to the longitudinal axis of the drum, whereby the slanted interior walls below the drum may be made shallower than the bark collecting walls 6 shown in FIG. 2.

By virtue of the solid-shell drum 4′, it is possible to dispose with the long bark discharge conveyor 7 located below the drum, the slanted bark collecting walls 6 and the dust hood 22 enclosing the drum that are required in a prior-art debarking process. Having the drum 4′ situated at a lower elevation level, also its foundation can be made shallower. The drum feed conveyor 41′, which is limited as to the maximum slope of its track, may in many cases be constructed shorter, whereby the only design constraint is dictated by the need for a sufficiently long thawing time required for frozen logs. The lower height of the debarking line building gives a substantial contribution to reduced investment costs.

As there is no need for arrangements to remove bark pieces via any bark discharge openings in the drum shell, the drum gate may be eliminated entirely when debarking wood species whose bark is easily removable. Actually, the gate is needed only in purposes for controlling and/or adjusting the log flow in the drum. Also the conical outlet end 44 of the drum (tapering angle α in the diagram) can be made less abrupt. Resultingly, wood loss is reduced and discharge of logs from the drum takes place at a smoother rate, whereby the debarking volume can be increased.

The debarking drum 4′ discharges the logs and dislodged bark pieces directly onto a roller track 9′. By way of replacing a drum discharge conveyor 8 by a roller track 9′, the bark separation capacity of the roller track can be improved without the need for increasing the travel distance from the drum to the chipper. The roller track 9′ comprises two sections, the first one being a fine solids separating roller set 34. A major portion of bark pieces and small pieces of wood are separated from the log flow not earlier than in the second section 35 of the roller set 9′. The gaps 10 provided between the rollers of the second section 35 are made wider than those of the roller set of the first section 34. These two roller sets 34, 35 placed on the chipper feed line replace the function of the disc screen 18 employed in a conventional debarking process. The finer particulate matter falling through the first roller set 34 is transported by conveyors 36 and 37 to further processing. Pieces falling off from the second roller set 35 are transported by conveyors 38 and 39 to a bark shredder 20 that discharges the comminuted pieces of bark and wood onto conveyor 37.

At the delivery end of the second section 35 of roller set 9′ is placed a rock trap 12 and a log washer 13′. The washer 13′ may be implemented using high-pressure jets, whereby the separation of bark pieces from the wood flow is enhanced. The wasted water of the rock trap 12 and the log washer, as well as bark pieces reaching the end portion of roller set 9′, land into a water trough 40 and therefrom travel further to a sieve drainer 19. From the drainer, the bark pieces are by conveyor 39 transported to a bark shredder 20.

In FIG. 5 is shown an embodiment of the invention adapted for debarking Acacia or Eucalyptus wood species. Inasmuch as the design length of the drum feed conveyor is not limited by the minimum required thawing time of logs, the shallower height of the drum facilitates a substantial shortening of the length A₂ of the drum feed conveyor 41″ as compared to its length A₁ as depicted in FIG. 3. Equally, the length of the bark collecting conveyor 25′ may be reduced. Also herein, the costs involved with the sealed enclosure of the drum can be neglected. As to its other details, the debarking process can be implemented from roller set 42 onwards in the downstream direction in the same fashion as shown in FIG. 3.

In FIG. 4 is shown also the measurement instrumentation required for the control of the debarking process. The amount of wood being fed into the drum is measured by means of a wood quantity sensor 43 adapted to operate alongside the drum feed conveyor and a conveyor speed sensor (not shown in the diagram). The retention time of debarking is monitored by drum weight sensing 44 and measurement of the rotational speed of the drum. The cleanliness of debarked logs is monitored either by a bark detector 45 located on the chipper feed line or a bark content analyzer 46 of chips located at the chipper discharge conveyor. A wood contents analyzer 47 is used for monitoring the removed bark flow. Most appropriately, equipment based on machine vision is employed in the measurement of wood content in bark pieces and cleanliness of debarked wood.

In FIG. 6 is shown in more detail the second section 35 of a roller track suitable for use in the invention. The interroll gaps 10 are made relatively wide as obviously is necessary already due to the use of helical flight rollers 47. The logs travel in the direction of arrow G. Further shown in FIG. 6 are the rotating directions of the individual rollers. The roller set also includes smooth-surfaced rollers 48 equipped with variable speed/direction drive. By virtue of the variable-speed drive of the rollers, the efficiency of the bark screening system can be adjusted to meet different operating conditions.

The entire debarking process is controlled and the degree of debarking completeness and loss of wood are optimized by way of controlling the drum feed conveyor speed, the rotating speed of the debarking drum, the position of the drum gate and the rotating speed or direction of the rollers of the bark screening roller track.

Accordingly, the benefits of the present invention and the debarking stations shown in FIGS. 4 and 5 are:

a short feed conveyor 41′, 41″,

in many cases a shorter debarking drum 4′,

no need for a bark discharge conveyor and bark collecting walls under the debarking drum,

a more durable drum 4′ of lesser weight,

lower noise level and reduced environmental noise emission level,

reduced dusting and soiling of operating environment,

screening of bark pieces on a roller track 34, 35,

lower wood losses,

lower height of debarking line building,

reduced sensitivity to disturbance,

lower maintenance costs,

reduced operating costs,

higher degree of utilization,

smaller need of installation space, and

lower investment costs.

1. A debarking method for logs, the method comprising an essentially continuously operating debarking process, wherein the logs to be debarked are fed into a cylindrical debarking drum (4′) having a drum shell, an open inlet end, an opposite essentially open discharge end and a longitudinal essentially horizontal central axis, the debarking drum is rotated around the central axis, the logs and their loosened bark are discharged from the debarking drum to a conveyor system, the logs are subjected to a mutual movements on said conveyor system in order to separate the loosened bark and the logs, wherein bark is loosened from the logs in a debarking drum (4′) having no bark discharge openings in the drum shell.

2. The method of claim 1, wherein a roller conveyor (9′) is used in said conveyor system.

3. The method of claim 1 wherein is used a debarking drum equipped with an outlet gate (43) at the discharge end.

4. The method of claim 1 for logs to be chipped, wherein the amount of wood being fed into the debarking drum is measured using sensor means for detecting prior to the inlet of the debarking drum the quantity level (43) and speed of wood traveling to the inlet of debarking drum, while the efficiency of the debarking process is monitored by way of measuring (45, 46, 47) the amount of wood being fed into the chipper or the bark content of chips or/and the wood content of removed bark.

5. The method of claim 2 wherein the debarking drum is equipped with an outlet gate (43) at the discharge end and the debarking and bark separation process according to the invention is controlled by adjusting at least one of the variable, the drum feed, the rotating speed of the debarking drum (4′), the position of the drum gate (43) and the rotating speed or direction of the rollers (48) of the roller conveyor (9′).

6. The debarking method of claim 5, wherein the method uses a roller conveyor comprising a leading section (34) for separating bark fines and a trailing section (35) for separating coarser pieces of bark and wood clumps, and that the fall-through discharge fraction of the trailing section is passed to classification and further processing.

7. A drum debarking apparatus for logs to be chipped, the apparatus comprising a drum feed conveyor (41′), a debarking drum (4′) and a roller conveyor (9′) for transferring debarked logs, characterized in that wherein said debarking drum (4′) has no bark discharge openings in the shell for removing loose bark from the drum and that said roller conveyor (9′) is equipped with rollers capable of vigorously moving logs in a lateral direction.

8. The debarking apparatus of claim 7, characterized in that wherein said roller conveyor is equipped with a high-pressure jet washer (13′).

9. The debarking apparatus of claim 7, wherein a number of the rollers of said roller conveyor (9′) are equipped with a separate control of their rotating speed and/or direction.

10. The debarking apparatus of claim 7, wherein said roller conveyor (9′) comprises a narrower-gap leading section (34) and wider-gap trailing section (35).

11. The debarking apparatus of claim 7, wherein the debarking drum shell at its inlet end is provided with discharge openings (31) for removal of sand and small rocks, and downstream from said openings with an internal annular stop ring (32) for collecting the same.

12. The debarking apparatus of claim 7, wherein the apparatus is equipped with sensor means for detecting the travel speed and quantity level of wood on the drum feed conveyor, as well as with sensor means for detecting the bark content of debarked logs, of chips produced from the logs and/or detecting the wood content of removed bark.

13. The debarking method of claim 2, wherein the method uses a roller conveyor comprising a leading section (34) for separating bark fines and a trailing section (35) for separating coarser pieces of bark and wood clumps, and that the fall-through discharge fraction of the trailing section is passed to classification and further processing.

14. The debarking apparatus of claim 8, wherein the apparatus is equipped with sensor means for detecting the travel speed and quantity level of wood on the drum feed conveyor, as well as with sensor means for detecting the bark content of debarked logs, of chips produced from the logs and/or detecting the wood content of removed bark.

15. The debarking apparatus of claim 9, wherein the apparatus is equipped with sensor means for detecting the travel speed and quantity level of wood on the drum feed conveyor, as well as with sensor means for detecting the bark content of debarked logs, of chips produced from the logs and/or detecting the wood content of removed bark.

16. The debarking apparatus of claim 10, wherein the apparatus is equipped with sensor means for detecting the travel speed and quantity level of wood on the drum feed conveyor, as well as with sensor means for detecting the bark content of debarked logs, of chips produced from the logs and/or detecting the wood content of removed bark.
